(19) United States
(12) Patent Application Publication
(10) Pub. No.: US 2020/0269615 A1
(43) Pub. Date: Aug. 27, 2020

(54) PRINTER

(71) Applicants: CITIZEN WATCH CO., LTD., Tokyo (JP); CITIZEN SYSTEMS JAPAN CO., LTD., Tokyo (JP)

(72) Inventor: Akira TAKAHASHI, Nagano (JP)

(21) Appl. No.: 16/798,389

(22) Filed: Feb. 23, 2020

(30) Foreign Application Priority Data
Feb. 27, 2019 (JP) 2019-033515

(51) Int. Cl. B41J 15/04; B41J 29/13; B41J 2/32; B65H 16/06

(52) U.S. Cl. CPC B41J 15/042; B41J 29/13; B65H 2402/45; B65H 16/06; B41J 2/32

(57) ABSTRACT

A printer includes a front cover to open and close an opening portion of a front surface of a box casing and a housing that is provided in the casing and in which roll paper held in a roll paper holder is housed through the opening portion. The roll paper holder includes flanges that are disposed in both end portions of the roll paper, respectively, and the flanges project from the opening portion when the roll paper is housed in the housing.

### CROSS-REFERENCE TO RELATED APPLICATION

The present application is based on and claims priority to Japanese patent application No. 2019-033515, filed on Feb. 27, 2019, the disclosure of which is hereby incorporated by reference herein in its entirety.

### BACKGROUND

The present disclosure relates to a printer.

Conventionally, a printer in which roll paper is housed in a housing inside a casing through an opening portion provided in a front surface of the casing is known (for example, see JP 6262429 B).

JP 6262429 B discloses a configuration including a cutout portion through which both end surfaces of the roll paper are exposed when the roll paper is housed in a roll paper housing. An operator can thereby take the roll paper out from the roll paper housing while holding both end surfaces of the roll paper.

### SUMMARY

However, the configuration described in JP 6262429B requires the operator to deeply put fingers into the casing so as to take the roll paper out.

It is, therefore, an object of the present disclosure is to provide a printer from which roll paper can be easily taken out without deeply putting fingers into the casing.

To achieve the above object, a printer of the present disclosure includes a front cover to open and close an opening portion of a front surface of a box casing and a housing that is provided in the casing and in which roll paper held in a roll paper holder is housed through the opening portion, wherein the roll paper holder includes flanges that are disposed in both end portions of the roll paper, respectively, and the flanges project from the opening portion when the roll paper is housed in the housing.

### BRIEF DESCRIPTION OF DRAWINGS

FIG. 1 is a perspective view illustrating a printer of an embodiment.

FIG. 2 is a perspective view illustrating the printer of the embodiment when a cover is open.

FIG. 3 is an exploded perspective view illustrating the printer of the embodiment when a trash box is removed.

FIG. 4 is a cross section view illustrating the printer of the embodiment.

FIG. 5 is a side view illustrating the printer of the embodiment.

FIG. 6 is a perspective view illustrating a front cover of the embodiment.

FIG. 7 is a perspective view illustrating a roll paper holder of the embodiment.

FIG. 8 is a view describing an exchange operation of the roll paper of the printer of the embodiment.

### DETAILED DESCRIPTION

Hereinafter, an embodiment for achieving a printer of the present disclosure is described with reference to drawings.

The printer in the embodiment is applied to a sublimation type thermal transfer printer.

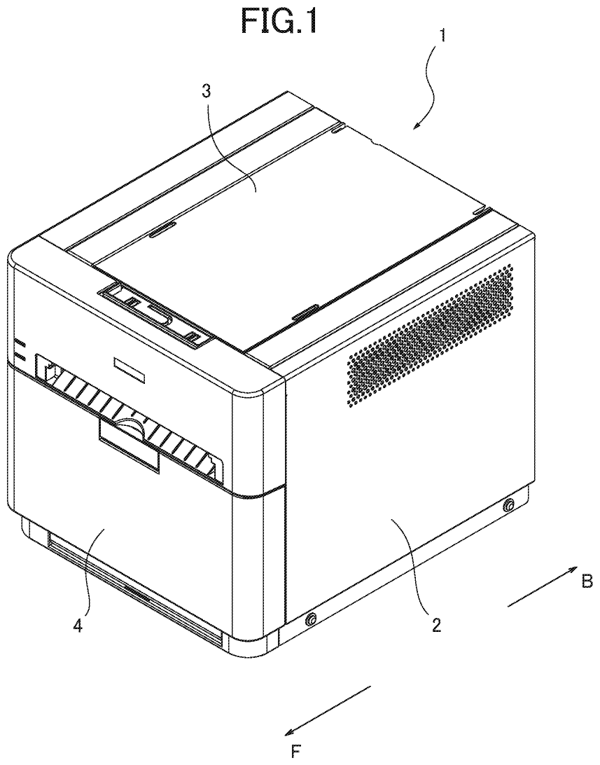

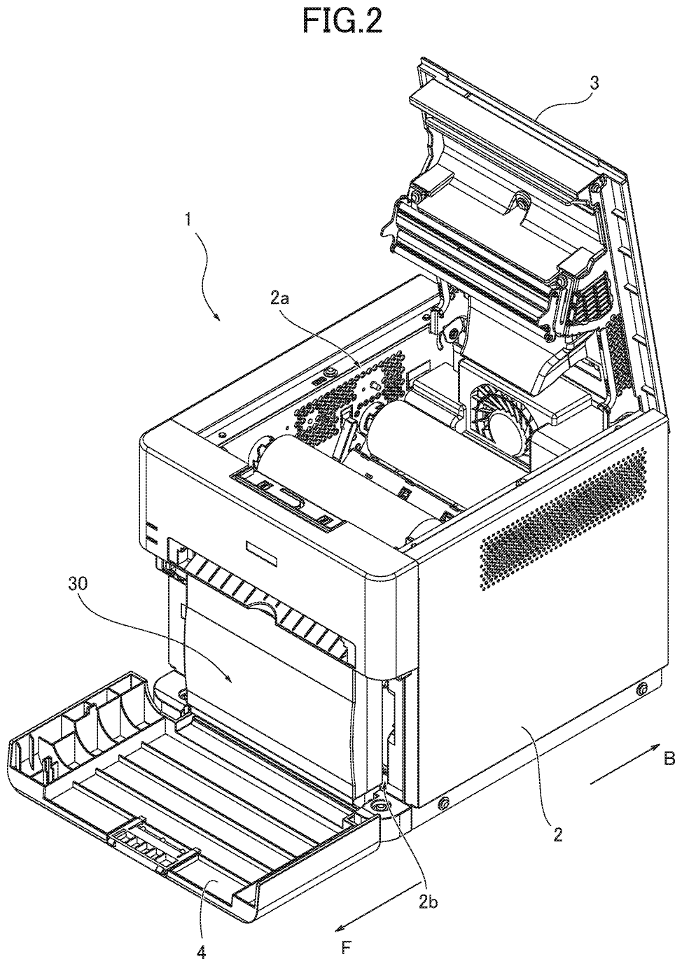

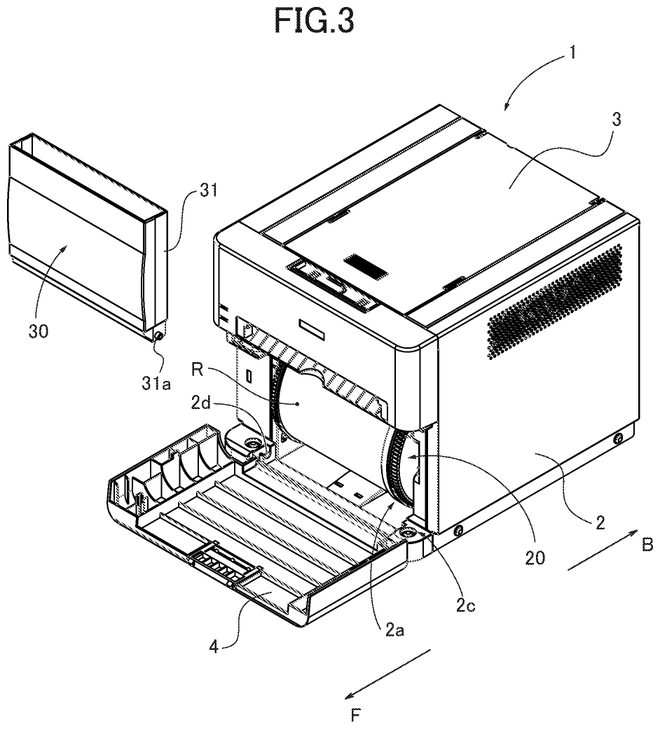

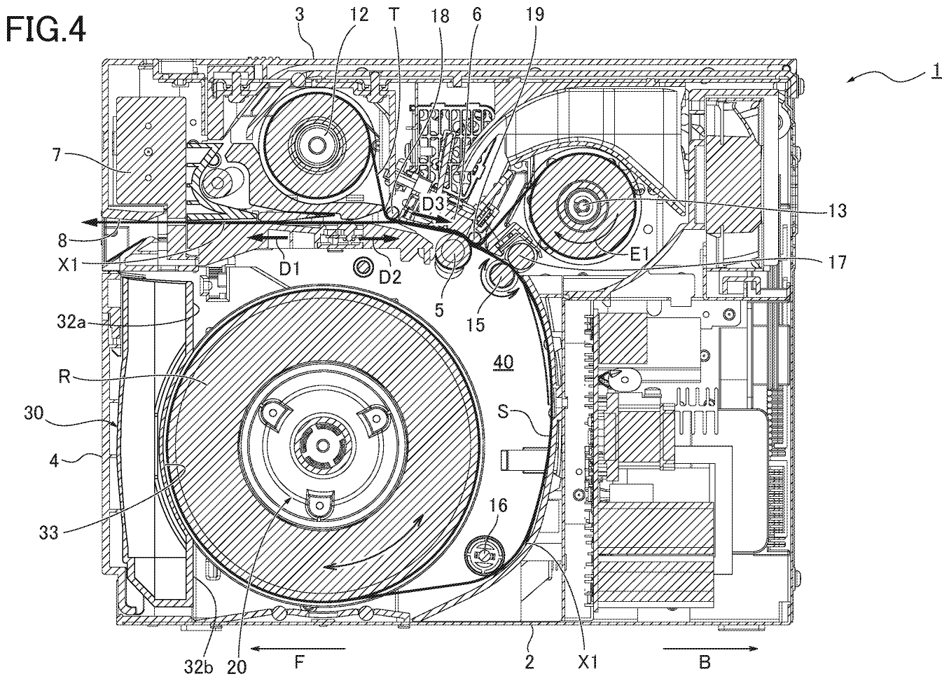

FIG. 1 is a perspective view illustrating the printer of the embodiment. FIG. 2 is a perspective view illustrating the printer of the embodiment when a cover is open. FIG. 3 is an exploded perspective view illustrating the printer of the embodiment when a trash box is removed. FIG. 4 is a cross section view illustrating the printer of the embodiment. Hereinafter, the configuration of the printer of the embodiment is described with reference to FIGS. 1 to 4. A forward direction F denotes the forward direction of the printer and a backward direction B denotes the backward direction of the printer.

As illustrated in FIGS. 1, 2, the printer 1 includes a box casing 2, an upper cover 3 as a cover provided in an upper opening portion 2a formed in a top surface of the casing 2, and front covers 4, 30 provided in a front opening portion 2b as an opening portion formed in the front surface of the casing 2.

As illustrated in FIG. 3, the front cover 4 is rotatably supported by a lower edge portion of the casing 2 which defines the front opening portion 2b, and is openable and closable relative to the front opening portion 2b.

As illustrated in FIG. 4, the casing 2 includes inside thereof roll paper R which supplies a sheet S as a recording medium, a roll paper holder 20 which holds the roll paper R, a housing 40 which houses the roll paper holder 20, an ink ribbon T, a thermal head 6 as an image forming portion, a platen roller 5, a cutter unit 7 as a cutting portion, and a driving roller 15 as a transport roller.

The sheet S fed from the roll paper R is wound around the driving roller 15 and a driven roller 16 as a transport roller, and is transported in a feeding direction D1 with a transport path X1 as a transport direction, and is discharged from an exit 8.

For example, photographic paper thicker than plain paper is used for the roll paper R. The roll paper R is rotatably held by the roll paper holder 20 connected to a motor.

The driving roller 15 and the driven roller 16 are attached to the casing 2, and are disposed along the transport path X1. The driving roller 15 is connected to a motor to be rotatable in a positive direction (counterclockwise direction) or a negative direction (clockwise direction) opposite to the positive direction. A counter roller 17 as a transport roller is disposed to face the driving roller 15.

The counter roller 17 is attached to the casing 2, and is disposed along the transport path X1. The counter roller 17 is configured to be movable to the driving roller 15. When the sheet S is transported, the counter roller 17 contacts the driving roller 15, and rotates in accordance with the driving roller 15. When the driving roller 15 rotates in the positive direction, the driving roller 15 and the counter roller 17 transport the sheet S in the feeding direction D1 while sandwiching the sheet therebetween. When the driving roller 15 rotates in the negative direction opposite to the positive direction, the driving roller 15 and the counter roller 17 transport the sheet S in a drawing back direction D2 as the transport direction while sandwiching the sheet S therebetween. The counter roller 17 separates from the driving roller 15 when the counter roller 17 and the driving roller 15 do not transport the sheet S.

The thermal head 6 is attached to the upper cover 3, and is disposed along the transport path X1. The thermal head 6 is disposed downstream of the driving roller 15 in the feeding direction D1 of the sheet S.

The platen roller 5 is attached to the casing 2, and is disposed to face the thermal head 6 along the transport path X1.

The cutter unit 7 is attached to the casing 2, and is disposed in front of the exit 8 in the feeding direction D1. The cutter unit 7 cuts the sheet S which is transported in the transport path X1.

The ink ribbon T is a band-shaped sheet including respective ink regions for yellow Y, magenta M, and cyan C and a region for overcoat OP, which are repeatedly disposed in a longitudinal direction (feeding direction). The ink ribbon T is held by a ribbon supply reel 12 which feeds the ink ribbon T and a ribbon winding reel 13 which winds the ink ribbon T.

The ribbon winding reel 13 is connected to a motor to rotate in a rotation direction E1. When the ribbon winding reel 13 rotates in the rotation direction E1, the ink ribbon T is fed from the ribbon supply reel 12. The ink ribbon T fed from the ribbon supply reel 12 is transported in a ribbon transport direction D3 to pass between the thermal head 6 and the platen roller 5 via the driven rollers 18, 19, and is wound around the ribbon winding reel 13.

The housing 40 is configured as a space in which the roll paper R held by the roll paper holder 20 can be housed through the front opening portion 2b.

Hereinafter, the operation of the printer 1 of the embodiment is described with reference to FIG. 3.

In the printer 1 configured as described above, upon the start of a printing operation after image data is input to the printer 1, as illustrated in FIG. 3, the roll paper holder 20 rotates and the driving roller 15 rotates in the positive direction, so that the sheet S fed from the roll paper R is transported in the feeding direction D1 along the transport path X1.

Next, the sheet S is transported in the drawing back direction D2, and the image is formed on the sheet S by the thermal head 6.

When the thermal head 6 is pressed to the platen roller 5 via the sheet S and the ink ribbon T, the thermal head 6 generates heat, and transfers sublimating dye ink applied to the ink ribbon T onto the same region of the sheet S to form an image on the sheet S.

The sheet S is repeatedly reciprocated in accordance with the formation of the image of each color (yellow Y, magenta M, cyan C, and overcoat OP), and an image in which the respective colors are combined is formed on the same region of the sheet S.

Next, the sheet S is transported in the feeding direction D1 along the transport path X1, cut by the cutter unit 7, and discharged from the exit 8. The trash (for example, cutting) discharged when the sheet S is cut by the cutter unit 7 is collected by the front cover 30 configured as a trash box.

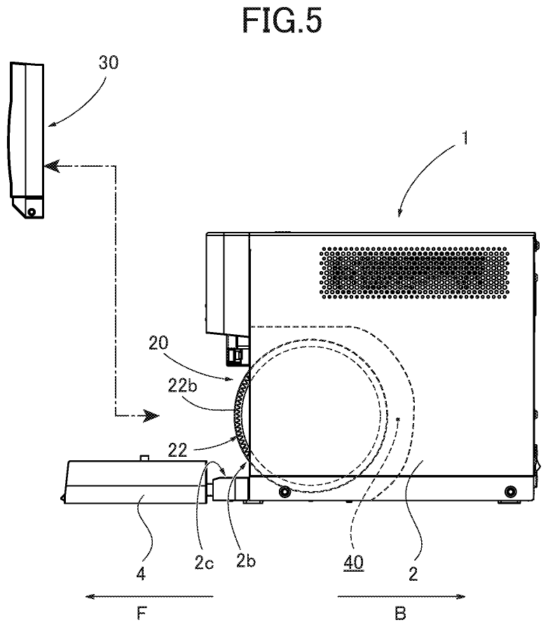

FIG. 5 is a side view illustrating the printer 1 of the embodiment. Hereinafter, the configuration of the casing 2 of the embodiment is described with reference to FIG. 5.

As illustrated in FIG. 5, cutout portions 2c are formed in the lower portion of the front surface of the casing 2. The cutout portion 2c has a rectangular shape when the printer 1 is seen from the side. More specifically, the cutout portions 2c are formed in side walls of the casing 2, respectively, which define the front opening portion 2b, to have rectangular shapes, respectively.

When the roll paper holder 20 to which the roll paper R is attached is housed in the housing 40, the front opening portion 2b locates behind the front surface of the printer 1 in the backward direction B as the cutout portions 2c are formed. When the roll paper holder 20 to which the roll paper R is attached is housed in the housing 40, the roll paper holder 20 projects from the front opening portion 2b in the forward direction F.

More specifically, when the roll paper holder 20 to which the roll paper R is attached is housed in the housing 40, the roll paper holder 20 projects from the casing 2 in the forward direction F as seen from the side of the printer 1.

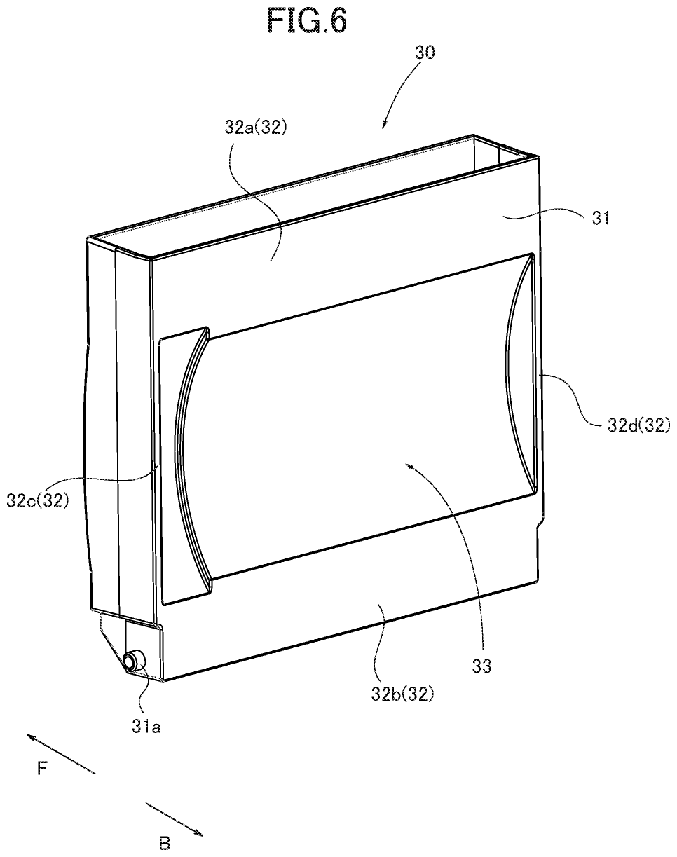

FIG. 6 is a perspective view illustrating the front cover 30 of the embodiment. The configuration of the front cover 30 of the embodiment is described with reference to FIGS. 3, 4, 6.

The front cover 30 is configured as a trash box. As illustrated in FIG. 6, the front cover 30 includes a front cover main body 31, a projection 31a, a concave portion 33, and a frame portion 32.

The front cover main body 31 is a box having an open top surface. The projection 31a is formed in the lower end portion of the side of the front cover main body 31. As illustrated in FIG. 3, in the front cover 30, the projection 31a is fitted into a U-shaped groove 2d provided in the lower edge portion of the casing 2 which defines the front opening portion 2b. The front cover 30 is thereby detachable to the front opening portion 2b.

As illustrated in FIGS. 4, 6, the concave portion 33 is formed in a flat rear surface of the front cover main body 31 to dent in the forward direction F, and has a circular arc shape in a cross section. When the front cover 30 is attached to the casing 2, the concave portion 33 covers a part of the roll paper holder 20, which projects from the front opening portion 2b in the forward direction F. In this case, the roll paper holder 20 to which the roll paper R is attached is housed in the housing 40.

As illustrated in FIG. 6, the frame portion 32 constitutes the flat rear surface of the front cover main body 31. The frame portion 32 includes an upper frame 32a disposed above the concave portion 33, a lower frame 32b disposed under the concave portion 33, and vertical frames 32c, 32d disposed on the sides of the concave portion 33. That is, the concave portion 33 is surrounded by the upper frame 32a, the lower frame 32b, and the vertical frames 32c, 32d.

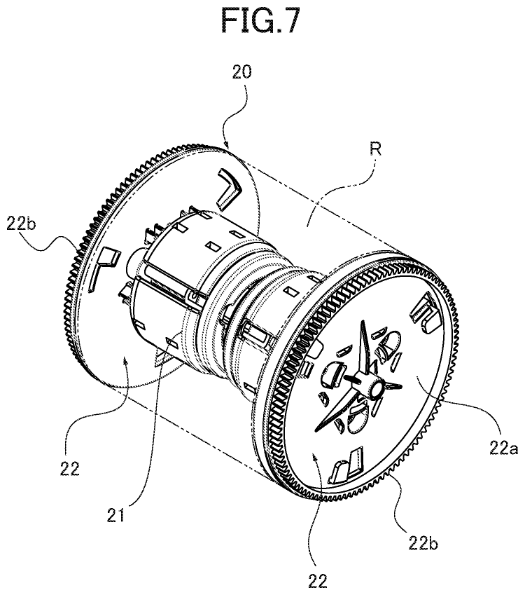

FIG. 7 is perspective view illustrating the roll paper holder 20 of the embodiment. Hereinafter, the configuration of the roll paper holder 20 of the embodiment is described with reference to FIG. 7.

The roll paper holder 20 is made from resin. As illustrated in FIG. 7, the roll paper holder 20 includes a holder main body 21 and flanges 22 formed in both end portions of the holder main body 21.

The holder main body 21 has a cylindrical shape. A core of the roll paper R is held by the holder main body 21, and the roll paper R is thereby held by the roll paper holder 20.

The flanges 22 are formed in both end portions of the holder main body 21 in the longitudinal direction, respectively. Each of the flanges 22 includes a disk-shaped flange main body 22a and a rising portion 22b that rises from the outer edge of the flange main body 22a.

The outer diameter of the flange main body 22a is substantially the same as the outer diameter of the unused roll paper R. The rising portion 22b rises from the outer edge of the flange main body 22a outwardly in the longitudinal direction of the holder main body 21. Teeth are provided in the outer circumference of the rising portion 22b to rotate the roll paper holder 20 via a gear connected to a motor.

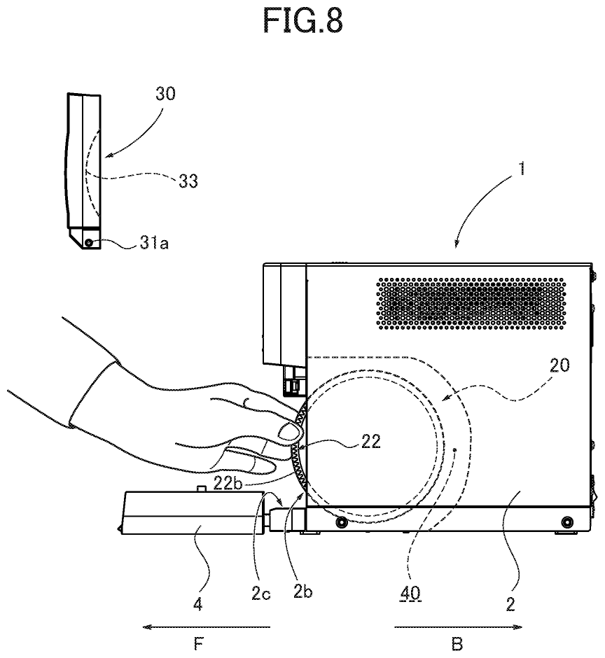

FIG. 8 is a view describing an exchange operation of the roll paper R of the printer 1 of the embodiment. The exchange operation of the roll paper R of the printer 1 according to the embodiment is described with reference to FIG. 8.

As illustrated in FIG. 8, when the roll paper R housed in the printer 1 is exchanged, at first, the front cover 4 is opened, and then the front cover 30 is removed. When the front cover 30 is removed, the flanges 22 of the roll paper holder 20 housed in the housing 40 project from the opening portion 2b in the forward direction F.

Next, an operator holds the rising portions 22b of the flanges 22 with fingers, and pulls the roll paper holder 20 in the forward direction F. Then, the operator takes the used roll paper R out from the roll paper holder 20, and attaches new roll paper R.

Next, the operator holds (sandwiches) the rising portions 22b of the flanges 22 with fingers, and houses the roll paper holder 20 to which the new roll paper R is attached in the housing 40 through the opening portion 2b. Next, the operator attaches the front cover 30. In this case, the front cover 30 is attached such that the concave portion 33 covers the flanges 22 and the roll paper R which project from the opening portion 2b in the forward direction F.

Next, the operator closes the front cover 4 to complete the exchange operation of the roll paper.

An operation of the printer according to the embodiment is described.

The printer 1 of the embodiment includes the front cover 30 to open and close the opening portion (front opening portion 2b) of the front surface of the box casing 2 and the housing 40 that is provided in the casing and in which the roll paper R held by the roll paper holder 20 can be housed through the opening portion (front opening 2b). The roll paper holder 20 includes the flanges 22 that are disposed in both end portions of the roll paper R. When the roll paper R is housed in the housing 40, the flanges 22 project from the opening portion (front opening portion 2b) (FIG. 4).

The operator can therefore hold the flanges 22 projecting from the opening portion (front opening portion 2b) with fingers for exchanging the roll paper R. The roll paper R can be therefore removed from the housing 40 with a simple configuration. As a result, the roll paper R can be easily exchanged with a simple configuration.

In the printer 1 of the embodiment, the cutout portions 2c are formed in the side walls of the casing 2 that defines the opening portion (front opening portion 2b) (FIG. 5).

The flanges 22 thereby project from the opening portion (front opening portion 2b) with a simple configuration when the roll paper R is housed in the housing 40.

In the printer 1 of the embodiment, the rear surface of the front cover 30 includes the concave portion 33 in which a part of the roll paper holder 20 can be housed (FIG. 6).

The front cover 30 can thereby cover a part of the roll paper holder 20 projecting from the opening portion (front opening portion 2b) without increasing the thickness of the front cover 30. The printer 1 can be therefore downsized, and the roll paper R and the roll paper holder 20 can be covered by the housing 40 and the front cover 30.

In the printer 1 of the embodiment, the concave portion 33 is formed inside the frame portion 32 of the rear surface of the front cover 30 (FIG. 6).

The connection between the front cover 30 and the casing 2 can be thereby made flat. The quality of the connection between the front cover 30 and the casing 2 can be improved to prevent foreign substances from entering the casing 2.

In the printer 1 of the embodiment, the flange 22 includes, in the outer edge thereof, the rising portion 22b that rises outwardly in the longitudinal direction of the roll paper R (FIG. 7).

The operator can thereby hold the rising portions 22b of the roll paper holder 20 with fingers for exchanging the roll paper R. The roll paper R can be therefore easily removed with a simple configuration.

In the printer 1 of the embodiment, the front cover 30 is a trash box in which the trash discharged when the sheet S fed from the roll paper R is cut is housed (FIG. 6).

A space for disposing the trash box can be thereby easily found in the sublimation type thermal transfer printer 1.

As described above, although the printer of the present disclosure is described based on the embodiment, the specific configurations are not limited to the embodiment. Any change in the design, addition, and the like are allowed as long as they do not depart from the scope of the invention according to each claim.

The embodiment shows the example in which the concave portion 33 is provided in the front cover 30. However, the concave portion can be provided in the front cover 4. In this case, the trash box as the front cover 30 may be provided in the front surface of the front cover 4.

The embodiment shows the example in which the front cover 4 and the front cover 30 are separated. However, the front cover 4 and the front cover 30 may be integrated.

The embodiment shows the example in which the cutout portion 2c has a rectangular shape. However, the cutout portion may have any shape as long as it has a size that allows the projection of the flanges of the roll paper holder housed in the housing from the opening portion to be held with fingers.

The embodiment shows the example in which the outer diameter of the flange 22 is substantially the same as the outer diameter of the unused roll paper R. However, the outer diameter of the flange may be smaller or larger than the outer diameter of the unused roll paper R.

The embodiment shows the example in which photographic paper is used as the sheet S. However, the sheet is not limited thereto. For example, plain paper may be used.

The embodiment shows the example in which the present disclosure is applied to the sublimation type thermal transfer printer 1. However, the present disclosure can be applied to a dot impact printer, a thermal printer, a laser printer, and an inkjet printer, for example.

What is claimed is:

1. A printer comprising:
a front cover to open and close an opening portion of a front surface of a box casing; and
a housing that is provided in the casing and in which roll paper held in a roll paper holder is housed through the opening portion, wherein
the roll paper holder includes flanges that are disposed in both end portions of the roll paper, respectively,
the flanges project from the opening portion when the roll paper is housed in the housing, and
the front cover is a trash box in which trash discharged when a sheet fed from the roll paper is cut is housed.

2. The printer according to claim 1, wherein cutout portions are formed in side walls of the casing, respectively, which define the opening portion.

3. The printer according to claim 1, wherein a rear surface of the front cover includes a concave portion in which a part of the roll paper holder is housed.

4. The printer according to claim 3, wherein the concave portion is formed inside a frame portion of the rear surface of the front cover.

5. The printer according to claim 1, wherein the flange includes, in an outer edge of the flange, a rising portion that rises outwardly in a longitudinal direction of the roll paper.
